(19) United States
(12) Patent Application Publication
(10) Pub. No.: US 2024/0149811 A1
(43) Pub. Date: May 9, 2024

(54) POWER SUPPLY CONTROL DEVICE

(71) Applicant: Sumitomo Wiring Systems, Ltd., Yokkaichi-shi, Mie (JP)

(72) Inventor: Kyohei MORITA, Yokkaichi-shi, Mie (JP)

(21) Appl. No.: 18/548,984

(22) PCT Filed: Feb. 16, 2022
(86) PCT No.: PCT/JP2022/006043

§ 371 Date: Sep. 5, 2023

(30) Foreign Application Priority Data
Mar. 9, 2021 (JP) 2021-037650

(51) Int. Cl. B60R 16/03; H02J 7/00

(52) U.S. Cl. CPC B60R 16/03; H02J 7/0068; H02J 7/007182

(57) ABSTRACT

A power supply control device includes a voltage conversion unit, a first switch, and a step-down unit. The voltage conversion unit performs voltage conversion between a second and a third conductive path. The first switch controls current flow from a first conductive path to the second conductive path. The step-down unit includes a step-down circuit that steps down a voltage applied to the third conductive path and outputs the resulting voltage. The step-down unit is configured to, when a voltage applied to the second conductive path decreases to an extent where the voltage reaches a predetermined value that is less than or equal to an output voltage of the step-down circuit, cause a current that is based on the output voltage of the step-down circuit to flow to the second conductive path.

### CROSS-REFERENCE TO RELATED APPLICATIONS

This application is the U.S. national stage of PCT/JP2022/006043 filed on Feb. 16, 2022, which claims priority of Japanese Patent Application No. JP 2021-037650 filed on Mar. 9, 2021, the contents of which are incorporated herein.

### TECHNICAL FIELD

The present disclosure relates to a power supply control device.

### BACKGROUND

JP 2009-234489A discloses an electronic control break power supply system for a vehicle. In the system disclosed in JP 2009-234489A, a backup power supply is provided with a first and second capacitor. When the ignition switch of the vehicle is turned on, the first capacitor is charged by an alternator. When the ignition switch of the vehicle is turned off, the second capacitor is connected in parallel to the first capacitor, and the second capacitor is charged by receiving some of the charge accumulated in the first capacitor.

When a power supply failure occurs in which power cannot be supplied from a power supply unit (main battery, etc.) to a load, the power supply system mounted in the vehicle performs a backup operation using power from a power storage unit that is different from the power supply unit.

In this type of power supply system, during the backup operation, a voltage conversion unit converts a voltage input from the power storage unit to a desired voltage and outputs the resulting voltage to supply power to a load. However, if there is a sudden increase in a current caused by a rush current flowing to the load during such voltage conversion, the output voltage of the voltage conversion unit may temporarily decrease.

The present disclosure provides a technology with which it is possible to suppress a decrease in the voltage on a predetermined path even if there is a large increase in a current flowing to a load during a backup operation where power is supplied to the load from a voltage conversion unit via the predetermined path.

### SUMMARY

A power supply control device that is one aspect of the present disclosure is a power supply control device to be used in a power supply system including a power supply unit, a power storage unit, a first power path along which power that is based on the power supply unit is supplied to a load, and a second power path along which power that is based on the power storage unit is supplied to the load, the power supply control device including a first conductive path that is a path along which power that is based on the power supply unit is transmitted; a second conductive path that is a path along which power is transmitted to the second power path, and is configured to be interposed between the second power path and the first conductive path; a third conductive path that is configured to be electrically connected to the power storage unit; a voltage conversion unit configured to perform voltage conversion between the second conductive path and the third conductive path; a switch that is provided between the first conductive path and the second conductive path, and is configured to switch between an on state where a current is allowed to flow from the first conductive path to the second conductive path and an off state where a current is blocked from flowing between the first conductive path and the second conductive path; and a step-down unit that includes a step-down circuit configured to step-down a voltage applied to the third conductive path and output the resulting voltage, and that is configured to, when a voltage applied to the second conductive path decreases to an extent where the voltage reaches a predetermined value that is less than or equal to an output voltage of the step-down circuit, cause a current that is based on the output voltage of the step-down circuit to flow to the second conductive path.

### Advantageous Effects

The technology according to the present disclosure can suppress a decrease in the voltage on a predetermined path even if there is a large increase in a current flowing to a load during a backup operation where power is supplied to the load from a voltage conversion unit via the predetermined path.

### BRIEF DESCRIPTION OF DRAWINGS

FIG. 1 is a circuit diagram schematically showing an example of an in-vehicle system including a power supply control device of the first embodiment.

FIG. 2 is a circuit diagram specifically illustrating a step-down unit and the like in the power supply control device of the first embodiment.

FIG. 3 is a diagram describing control (first control) performed when the power supply control device of the first embodiment charges a power storage unit, in the in-vehicle system in FIG. 1.

FIG. 4 is a diagram describing control (second control) performed when the power supply control device of the first embodiment prepares to perform a backup operation, in the in-vehicle system in FIG. 1.

FIG. 5 is a diagram describing an example where, when a power supply failure occurs during the second control in the in-vehicle system in FIG. 1, a current flows from a second power path to a common conductive path and no current is supplied from a step-down unit to the second power path.

FIG. 6 is a diagram describing an example where, when a power supply failure occurs during the second control in the in-vehicle system in FIG. 1, a current flows from the second power path to the common conductive path and a current flows from the step-down unit to the second power path.

FIG. 7 is a diagram describing control (third control) performed when the power supply control device of the first embodiment prepares to perform a backup operation, in the in-vehicle system in FIG. 1.

FIG. 8 is a diagram describing an example where, when a power supply failure occurs during the third control in the in-vehicle system in FIG. 1, a current flows from the second power path to the common conductive path and no current is supplied from the step-down unit to the second conductive path.

FIG. 9 is a diagram describing an example where, when a power supply failure occurs during the third control in the in-vehicle system in FIG. 1, a current flows from the second power path to the common conductive path and a current flows from the step-down unit to the second conductive path.

### DETAILED DESCRIPTION OF PREFERRED EMBODIMENTS

Embodiments of the present disclosure are listed and described below. Note that the features of the following (1) to (4) may be combined, provided no contradiction arises.

A power supply control device to be used in a power supply system including a power supply unit, a power storage unit, a first power path along which power that is based on the power supply unit is supplied to a load, and a second power path along which power that is based on the power storage unit is supplied to the load, the power supply control device including: a first conductive path that is a path along which power that is based on the power supply unit is transmitted; a second conductive path that is a path along which power is transmitted to the second power path, and is configured to be interposed between the second power path and the first conductive path; a third conductive path that is configured to be electrically connected to the power storage unit; a voltage conversion unit configured to perform voltage conversion between the second conductive path and the third conductive path; a switch that is provided between the first conductive path and the second conductive path, and is configured to switch between an on state where a current is allowed to flow from the first conductive path to the second conductive path and an off state where a current is blocked from flowing between the first conductive path and the second conductive path; and a step-down unit that includes a step-down circuit configured to step-down a voltage applied to the third conductive path and output the resulting voltage, and that is configured to, when a voltage applied to the second conductive path decreases to an extent where the voltage reaches a predetermined value that is less than or equal to an output voltage of the step-down circuit, cause a current that is based on the output voltage of the step-down circuit to flow to the second conductive path.

The power supply control device in (1) can, if the voltage of the second conductive path has not decreased to an extent where it reaches the predetermined value during a backup operation where the voltage conversion unit applies an output voltage to the second conductive path, utilize the advantages of the voltage conversion unit by causing the voltage conversion unit to stop the passage of a current from the step-down unit to the second conductive path. On the other hand, the power supply control device in (1) can, if a current flowing to the load suddenly increases and the voltage of the second conductive path decreases to an extent where it reaches the predetermined value during the backup operation, suppress a decrease in the voltage of the second conductive path by causing a current to flow from the step-down unit to the second conductive path.

For example, as a comparative example compared to the power supply control device in (1), a configuration is also conceivable where a capacitor is installed in the power supply control device in place of the step-down unit, and the capacitor is discharged to the load when there is a sudden increase in the current flowing to the load to suppress a decrease in voltage. However, in such a configuration, the larger the required current is, the larger the capacitor needs to be, which leads to a problem in that the size of the device and cost tend to increase. However, the power supply control device in (1) makes it easier to realize a configuration that can suppress a decrease in the output voltage of the voltage conversion unit and suppress an increase in the size of the device.

In the power supply control device in (1), the step-down circuit is a low dropout regulator.

The power supply control device in (2) can realize a configuration in which it is possible to, when the voltage of the second conductive path suddenly decreases to the extent where it reaches the predetermined value, quickly cause a current to flow to the second conductive path and suppress a decrease in voltage, with a smaller configuration. Furthermore, even if the voltage conversion unit cannot appropriately respond to feedback, the voltage of the second conductive path can easily be stabilized by the output of the low dropout regulator.

In the power supply control device in (1) or (2), the step-down unit has a diode, and the voltage output by the step-down circuit is applied to an anode of the diode, and a cathode of the diode is electrically connected to the second conductive path.

The power supply control device in (3) can, when the voltage of the second conductive path has decreased to the extent that the potential difference between the anode and the cathode of the diode exceeds the forward voltage of the diode, immediately supply a current that is based on output of the step-down circuit to the second conductive path.

The power supply control device according to any one of (1) to (3) has the following features. The power supply control device also includes a control unit configured to control the switch and the voltage conversion unit. The control unit performs first control and second control. The first control is control for turning on the switch and causing the voltage conversion unit to perform a first conversion operation of stepping down or stepping up a voltage applied to the second conductive path and applying the resulting voltage as an output voltage to the third conductive path. The second control is control for turning off the switch and causing the voltage conversion unit to perform a second conversion operation of stepping down or stepping up a voltage applied to the third conductive path and applying the resulting voltage as an output voltage of a target value to the second conductive path. The target value is a value that is higher than the predetermined value. The step-down circuit outputs a voltage that is lower than the target value.

The power supply control device in (4) can charge the power storage unit by executing the first control to cause the voltage conversion unit to perform the first conversion operation, and can discharge the power storage unit by executing the second control to cause the voltage conversion unit to perform the second conversion operation. The power supply control device can easily keep the second conductive path and the second power path near the target value while executing the second control, and can go on stand-by or supply power to the load in a state where the voltage near the target value is output. On the other hand, if the current flowing through the second conductive path and the second power path suddenly increases while the second control is being executed, and the voltage of the second conductive path rapidly decreases to an extent where it reaches the predetermined value, a current can be caused to quickly flow from the step-down unit to the second conductive path, and thus a further decrease in the voltage can be suppressed.

### First Embodiment

### Outline of In-Vehicle System

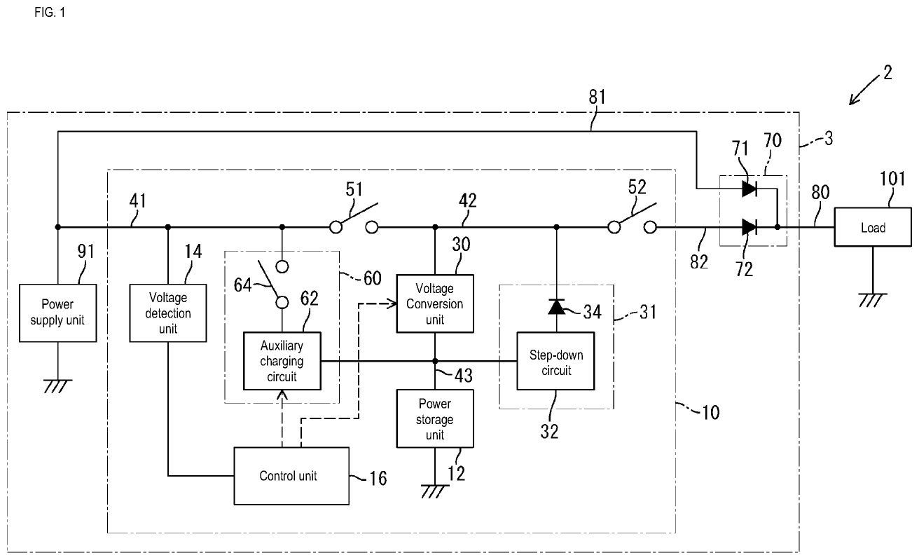

FIG. 1 shows an in-vehicle system 2. The in-vehicle system 2 shown in FIG. 1 mainly includes an in-vehicle power supply system 3 and a load 101. The in-vehicle power supply system 3 is also referred to as the power supply system 3 in the following description. The in-vehicle system 2 is a system that uses the power supply system 3 to supply power to the load 101 and cause the load 101 to operate. In FIG. 1, the load 101 is illustrated as an in-vehicle load, but other loads may be provided in the in-vehicle system 2. The load 101 is an electric component mounted in a vehicle. The load 101 operates by receiving power supplied via a common power path 80. The type of load 101 is not limited. Various known in-vehicle components may be employed as the load 101. The load 101 may have more than one electric component or be a single electric component.

The power supply system 3 is a system for supplying power to the load 101. The power supply system 3 supplies power to the load 101 using a power supply unit 91 or a power storage unit 12 as a power supply source. The power supply system 3 can supply power from the power supply unit 91 to the load 101, and, when the supply of power from the power supply unit 91 is interrupted by a failure or the like, can supply power to the load 101 from the power storage unit 12.

### Outline of Power Supply System

The power supply system 3 includes the power supply unit 91, the power storage unit 12, a power supply control device 10, a first power path 81, a second power path 82, and a selection unit 70.

The power supply unit 91 is an in-vehicle power supply that can supply power to the load 101. The power supply unit 91 is constituted by a known in-vehicle battery such as a lead battery. The power supply unit 91 may be constituted by a battery other than a lead battery, and may have, instead of a battery or in addition to a battery, a power supply means other than a battery. The positive electrode of the power supply unit 91 is electrically connected to the first power path 81 by being short-circuited to the first power path 81. The negative electrode of the power supply unit 91 is electrically connected to ground by being short-circuited to ground. The power supply unit 91 applies a DC voltage of a fixed value to the first power path 81. The voltage applied to the first power path 81 by the power supply unit 91 may slightly vary from the above fixed value.

The power storage unit 12 is a power supply that serves as a power supply source when at least the supply of power from the power supply unit 91 is interrupted. The power storage unit 12 is configured by a known power storage means such as an electric double layer capacitor (EDLC). The power storage unit 12 may be constituted by a capacitor other than an EDLC, and may include, in place of or in addition to a capacitor, another power storage means (a battery, etc.). The positive electrode of the power storage unit 12 is electrically connected to a third conductive path 43 by being short-circuited to the third conductive path 43. The negative electrode of the power storage unit 12 is electrically connected to ground by being short-circuited to ground. The output voltage of the power storage unit 12 (the voltage applied to the third conductive path 43 by the power storage unit 12) may be larger or smaller than the output voltage of the power supply unit 91 (the voltage applied to the first power path 81 by the power supply unit 91). In the representative example described below, the output voltage of the fully charged power storage unit 12 is larger than the output voltage of the fully charged power supply unit 91.

In the present specification, unless specifically limited, the voltage is a voltage relative to the ground potential (for example, 0 V), and is a potential difference with the ground potential. The voltage applied to the first power path 81 is, for example, the potential difference between the potential of the first power path 81 and the ground potential. The voltage applied to the third conductive path 43 is the potential difference between the potential of the third conductive path 43 and the ground potential.

The first power path 81 is a path along which power that is based on the power supply unit 91 is transmitted, and power that is based on the power supply unit 91 is supplied to the load 101. In the example shown in FIG. 1, a voltage that is equal to or substantially equal to the output voltage of the power supply unit 91 is applied to the first power path 81. One end of the first power path 81 is electrically connected to the positive electrode of the power supply unit 91 by being short-circuited to the positive electrode. The other end of the first power path 81 is electrically connected to an anode of a diode 71. The first power path 81 is electrically connected to a first conductive path 41 by being short-circuited to the first conductive path 41. The first power path 81 may be provided with a relay and a fuse.

The second power path 82 is a path along which power that is based on the power storage unit 12 is transmitted. The second power path 82 functions as a path along which power that is based on the power storage unit 12 is supplied to the load 101 during a power supply failure. One end of the second power path 82 is electrically connected to the other end of a second switch 52, and the other end of the second power path 82 is electrically connected to an anode of a diode 72.

The selection unit 70 is a circuit that selects whether power to be supplied to the load 101 is power that is based on the power supply unit 91 or power that is based on the power storage unit 12. The selection unit 70 includes the diodes 71 and 72.

The anode of the diode 71 is electrically connected to the first power path 81. A voltage that is based on the power supply unit 91 is applied to the anode of the diode 71. In the example shown in FIG. 1, the potential of the anode of the diode 71 is the same as that of the first power path 81, and the anode of the diode 71 and the positive electrode of the power supply unit 91 are short-circuited to each other. The anode of the diode 72 is electrically connected to the second power path 82. The potential of the anode of the diode 72 is the same as that of the second power path 82. The cathodes of the diodes 71 and 72 are both electrically connected to the common power path 80, and both cathodes have the same potential as that of the common power path 80. The common power path 80 is a conductive path that is electrically connected to the load 101. When the potential of the first power path 81 is greater than the potential of the second power path 82, the selection unit 70 allows a current to flow from the first power path 81 to the common power path 80 and does not allow a current to flow from the second power path 82 to the common power path 80. When the potential of the second power path 82 is greater than the potential of the first power path 81, the selection unit 70 allows a current to flow from the second power path 82 to the common power path 80 and does not allow a current to flow from the first power path 81 to the common power path 80.

Details about Charge/Discharge Control Device

The power supply control device 10 is a backup device that can output power that is based on the power storage unit 12. The power supply control device 10 includes the first conductive path 41, the second conductive path 42, the third conductive path 43, a first switch 51, the second switch 52, a voltage conversion unit 30, an auxiliary charging unit 60, a step-down unit 31, a voltage detection unit 14, a control unit 16, and the power storage unit 12.

The first conductive path 41 is a path along which power that is based on the power supply unit 91 is transmitted. A voltage that is equal to or substantially equal to the output voltage of the power supply unit 91 is applied to the first conductive path 41. One end of the first conductive path 41 is electrically connected to the first power path 81. The potential of the first conductive path 41 is the same as the potential of a part of or the entire first power path 81, for example. The other end of the first conductive path 41 is electrically connected to one end of the first switch 51.

The second conductive path 42 is a conductive path that is interposed between the second power path 82 and the first conductive path 41, and is also interposed between the first conductive path 41 and the voltage conversion unit 30. The second conductive path 42 is a path along which power is transmitted to the second power path 82. When the later-described first switch 51 is on, the first conductive path 41 and the second conductive path 42 are short-circuited to each other via the switch 51. When the later-described second switch 52 is on, the second conductive path 42 and the second power path 82 are short-circuited to each via the switch 52.

The third conductive path 43 is a conductive path that is electrically connected to the power storage unit 12, and is also electrically connected to one end of the voltage conversion unit 30. When the voltage conversion unit 30 is stopped, the output voltage of the power storage unit 12 is applied to the third conductive path 43.

The first switch 51 is a switch that is provided between the first conductive path 41 and the second conductive path 42. The first switch 51 corresponds to an example of a switch. The first switch 51 switches between an on state in which a current is allowed to flow from the first conductive path 41 to the second conductive path 42, and an off state in which the flow of the current is blocked. For example, when the first switch 51 is on, a current is allowed to flow bidirectionally between the first conductive path 41 and the second conductive path 42. When the first switch 51 is off, a current is blocked from flowing bidirectionally between the first conductive path 41 and the second conductive path 42.

The second switch 52 is a switch that is provided between the second conductive path 42 and the second power path 82. The second switch 52 switches between an on state in which a current is allowed to flow from the second conductive path 42 to the second power path 82, and an off state in which the flow of the current is blocked. For example, when the second switch 52 is on, a current is allowed to flow bidirectionally between the second conductive path 42 and the second power path 82. When the second switch 52 is off, a current is blocked from flowing bidirectionally between the second conductive path 42 and the second power path 82.

The voltage conversion unit 30 is a device that performs voltage conversion between the second conductive path 42 and the third conductive path 43. The voltage conversion unit 30 is constituted by a known voltage conversion circuit such as a DC/DC converter. The voltage conversion unit 30 can perform a first conversion operation of stepping down or stepping up a DC voltage applied to the second conductive path 42 and applying the resulting voltage as an output voltage to the third conductive path 43. For example, as a result of the voltage conversion unit 30 performing the first conversion operation when the first switch 51 is on, a charging current that is based on power from the power supply unit 91 is supplied to the power storage unit 12. The voltage conversion unit 30 can perform a second conversion operation of stepping down or stepping up a DC voltage applied to the third conductive path 43 and applying the resulting voltage as an output voltage to the second conductive path 42. For example, as a result of the voltage conversion unit 30 performing the second conversion operation when the first switch 51 is off and the second switch 52 is on, a DC voltage that is based on power from the power storage unit 12 is applied to the second conductive path 42 and the second power path 82. The operation of the voltage conversion unit 30 is controlled by the control unit 16.

The auxiliary charging unit 60 is a device that charges the power storage unit 12 via a path different from a path including the voltage conversion unit 30. The auxiliary charging unit 60 includes a third switch 64 and an auxiliary charging circuit 62. The auxiliary charging unit 60 switches between a supply state in which power that is based on power supplied via the first conductive path 41 is supplied to the power storage unit 12 via a path different from a path including the voltage conversion unit 30, and a stopped state in which the supply of power to the power storage unit 12 via this path (the path different from the path including the voltage conversion unit 30) is stopped. The above “path different from the path including the voltage conversion unit 30” is a path that extends through the third switch 64 and the auxiliary charging circuit 62, and is a path that does not extend through the first switch 51 and the voltage conversion unit 30.

The third switch 64 switches between a conductive state in which the first conductive path 41 and the auxiliary charging circuit 62 are electrically connected, and a blocking state. When the third switch 64 is on, power is supplied from the power supply unit 91 to the auxiliary charging circuit 62 via the first conductive path 41 and the third switch 64. When the third switch 64 is off, the passage of a current in two directions via the third switch 64 is blocked, and no current flows from the first conductive path 41 to the auxiliary charging circuit 62.

The auxiliary charging circuit 62 is a circuit that can supply a charging current to the power storage unit 12 when the third switch 64 is on. The auxiliary charging circuit 62 may be a low dropout regulator (LDO), a DC/DC converter, or another charging circuit. When another charging circuit is used, various methods such as constant-voltage charging, constant-current charging, and constant-voltage/constant-current charging can be employed. The control unit 16 is an information processing device that has functions including information processing, computation, and control functions. The control unit 16 can perform control to cause the voltage conversion unit 30 to perform the first conversion operation and control to cause the voltage conversion unit 30 to perform the second conversion operation. The control unit 16 turns the first switch 51, the second switch 52, and the third switch 64 on and off. The control unit 16 performs the later-described, first control, second control, and third control.

The voltage detection unit 14 is a circuit that outputs an analogue voltage value indicating a value that can specify the value of a voltage applied to the first conductive path 41. The voltage detection unit 14 may be a circuit that inputs a voltage value equal to the value of the voltage applied to the first conductive path 41 to the control unit 16 or a circuit that inputs a value proportionate to the value of a voltage applied to the first conductive path 41 to the control unit 16. In the example shown in FIG. 1, for example, the voltage detection unit 14 is a voltage divider circuit, and a value obtained by the voltage divider circuit dividing the value of the voltage applied to the first conductive path 41 is input to the control unit 16 as a detection value. The control unit 16 specifies the value of the voltage applied to the first conductive path 41 based on the detection value (analogue voltage value) received from the voltage detection unit 14.

In the power supply control device 10 shown in FIG. 1, the first switch 51, the second switch 52, and the third switch 64 may each be a semi-conductor switch such as an FET or a mechanical relay.

The step-down unit 31 is a circuit that, when a value V2 of a voltage applied to the second conductive path 42 decreases to the extent where it reaches a predetermined value that is less than or equal to a value Vb of the output voltage of the step-down circuit 32, causes a current that is based on the output voltage of the step-down circuit 32 to flow to the second conductive path 42. The step-down unit 31 includes the step-down circuit 32 and a diode 34. Specifically, Vb−Vf corresponds to an example of the above predetermined value, Vb−Vf being a value obtained by subtracting a value Vf of the forward voltage of the diode 34 from the value Vb of the output voltage of the step-down circuit 32.

The step-down circuit 32 is a circuit that uses the voltage applied to the third conductive path 43 as an input voltage, and steps-down this input voltage and outputs the resulting voltage as a predetermined voltage. The step-down circuit 32 is a low dropout regulator, for example. In the following description, the voltage value input to the step-down circuit 32 is represented by Va, and the voltage value output by the step-down circuit 32 is represented by Vb. The voltage value Va is the value of the voltage applied to the third conductive path 43. The voltage value Vb is the value of the voltage applied to the anode of the diode 34.

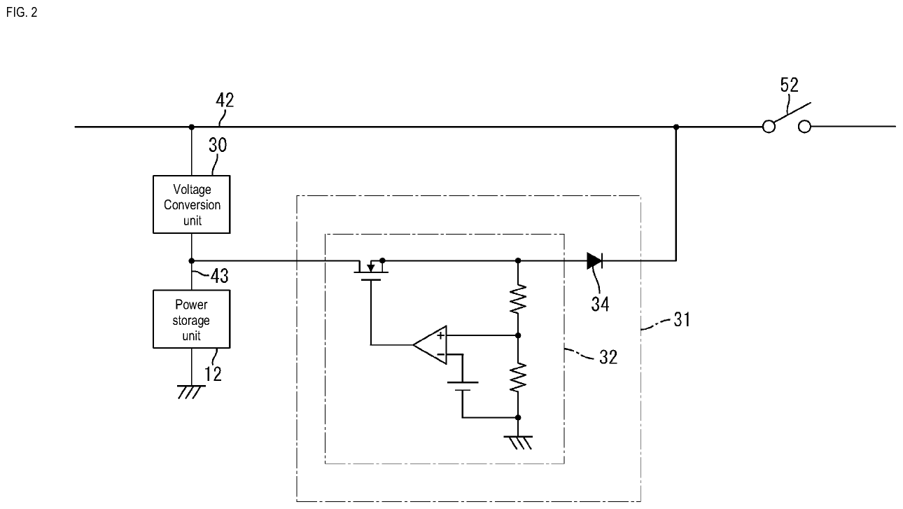

FIG. 2 shows an example where the step-down circuit 32 is a low dropout regulator. The step-down circuit 32 can perform a step-down operation without being controlled by the control unit 16. In the step-down unit 31, the voltage output by the step-down circuit 32 is applied to the anode of the diode 34, and the cathode of the diode is electrically connected to the second conductive path 42. In the step-down unit 31, if the output voltage value Vb of the step-down circuit 32 is kept at the predetermined value, and the relation between the voltage value V2 of the second conductive path 42 and the output voltage value Vb of the step-down circuit 32 is V2<Vb and Vb−V2 exceeds the forward voltage Vf of the diode 34, a current that is based on power from the power storage unit 12 is caused to flow to the second conductive path 42 via the diode 34.

### Operation of Charge/Discharge Control Device

### First Control

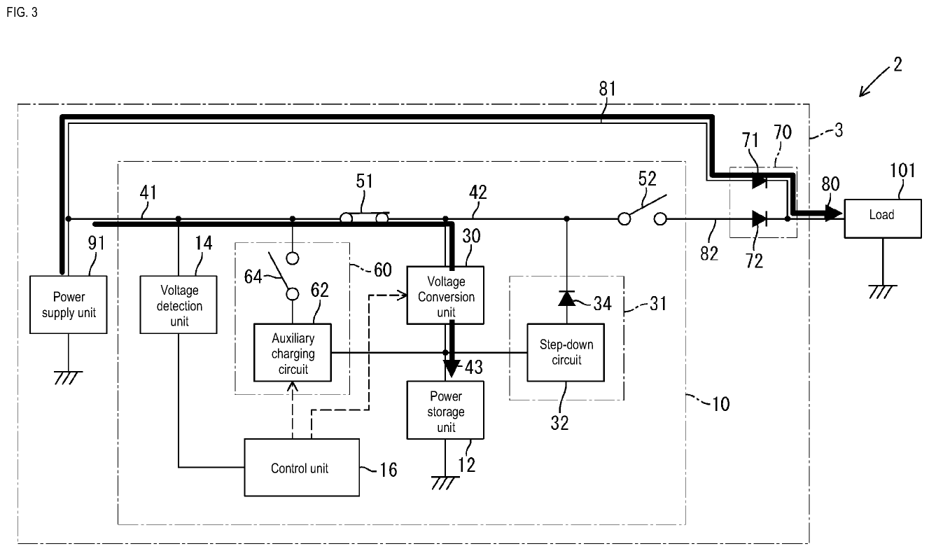

FIG. 3 is a diagram describing the first control. When a predetermined first condition is met, the control unit 16 initiates the first control. The above “first condition” may be, for example, the condition “the vehicle is started”, or another condition. For example, if the vehicle in which the in-vehicle system 2 is mounted is started (a start switch such as an ignition switch is turned on), the control unit 16 determines that the first condition has been met, and initiates the first control.

The first control is control for charging the power storage unit 12 using a first charging method. For example, if an electric double layer capacitor in which the charge amount and output voltage are in a proportionate relationship is used as the power storage unit 12, the output voltage of the power storage unit 12 can change from 0 V to a voltage higher than the output voltage of the power supply unit 91. The first control is control for turning on the first switch 51 and causing the voltage conversion unit 30 to perform an operation of stepping up the voltage applied to the second conductive path 42 and applying the resulting voltage to the third conductive path 43. In the example shown in FIG. 3, the control unit 16 performs the first control so as to turn off the third switch 64 in addition to the second switch 52. The control unit 16 performs the first control such that a value that is greater than the charging voltage of the fully charged power storage unit 12 and is greater than the charging voltage of the fully charged power supply unit 91 is a first target value, and that the output voltage applied by the voltage conversion unit 30 to the third conductive path 43 is the first target value. The control unit 16 executes the first control until a termination condition of the first control is met. The termination condition of the first control may be that the charging voltage of the power storage unit 12 has reached a predetermined value (for example, a later-described second threshold), that a certain period of time has passed from when the first control was initiated, or another condition being met.

While the control unit 16 is performing the first control, the voltage conversion unit 30 performs the aforementioned first conversion operation, with the first switch 51 kept on, and the second switch 52 and the third switch 64 kept off, as shown in FIG. 3. With such an operation, a charging current that is based on power from the power supply unit 91 is supplied to the power storage unit 12, as indicated by the thick arrows in FIG. 3.

### Second Control

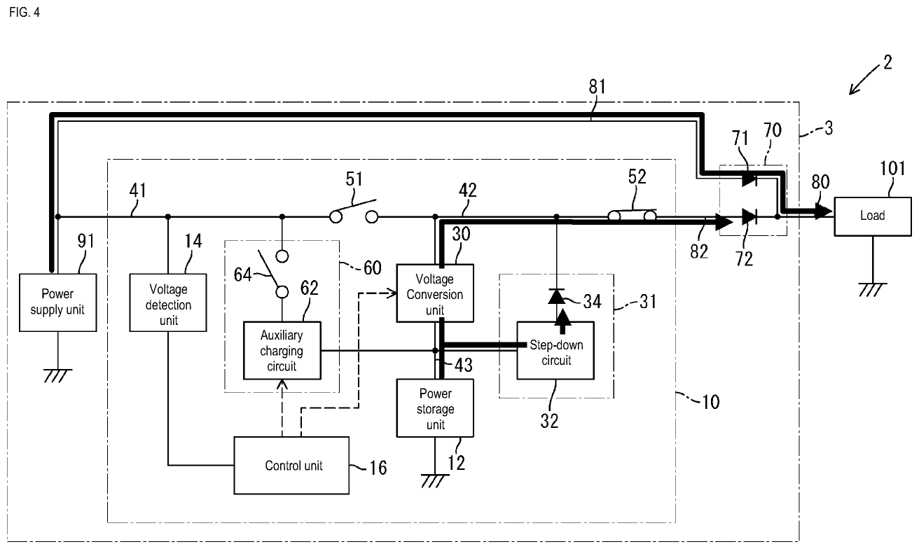

FIG. 4 is a diagram describing a second control. When a predetermined second condition is met, the control unit 16 initiates the second control. The above “second condition” may be, for example, the condition “the first control is ended”, the condition “the third control is ended”, or another condition. The second control is control for stopping charging of the power storage unit 12, and discharging the power storage unit 12. Specifically, the second control is control for turning off the first switch 51, turning on the second switch 52, stopping the auxiliary charging unit 60, and causing the voltage conversion unit 30 to perform an operation of stepping-down the voltage applied to the third conductive path 43 and applying the resulting voltage to the second conductive path 42. In the example shown in FIG. 4, the control unit 16 performs the second control so as to turn off the third switch 64 in addition to the first switch 51. The control unit 16 performs the second control such that a value that is smaller than the charging voltage of the fully charged power storage unit 12 and is slightly smaller than the charging voltage of the fully charged power supply unit 91 is a second target value, and that the output voltage applied by the voltage conversion unit 30 to the second conductive path 42 is the second target value. Note that the second target value is larger than Vb−Vf, which is the aforementioned predetermined value, and is greater than the output voltage value Vb of the step-down circuit 32. The second target value corresponds to an example of a “target value”.

While the control unit 16 is performing the second control, the voltage conversion unit 30 performs the aforementioned second conversion operation, with the second switch 52 kept on, and the first switch 51 and the third switch 64 kept off, as shown in FIG. 4. With such an operation, a voltage that is based on power from the power storage unit 12 is applied to the second power path 82 via the voltage conversion unit 30, as indicated by the thick arrows shown in FIG. 4. While the voltage conversion unit 30 is keeping the voltage value V2 of the second conductive path 42 at the second target value as the control unit 16 performs the second control, V2>Vb−Vf is realized, and thus no current flows through the diode 34. Accordingly, in this case, no current is output from the step-down unit 31 to the second conductive path 42, as shown in FIG. 4. Note that, if the termination condition of the second control is met during execution of the second control, the control unit 16 terminates the second control. The termination condition of the second control may be that the start switch of the vehicle in which the in-vehicle system 2 is mounted is turned off, an initiation condition of a third control (third condition) being met, or another condition.

The value (second target value) of the voltage applied by the voltage conversion unit 30 to the second conductive path 42 according to the second control is slightly smaller than the value of the voltage applied to the first power path 81 when the power supply unit 91 is fully charged. Thus, as long as the power supply unit 91 is fully charged and operating normally (not in a failure state, and can appropriately supply power that is based on the power supply unit 91 to the load 101), a current is allowed to flow from the first power path 81 to the common power path 80, and no current is allowed to flow from the second power path 82 to the common power path 80, as shown in FIG. 4. Specifically, if the voltage applied to the end portion of the first power path 81 (the anode of the diode 71) is greater than the voltage applied to the end portion of the second power path 82 (the anode of the diode 72), out of the first power path 81 and the second power path 82, only the current from the first power path 81 flows to the common power path 80, as shown in FIG. 4.

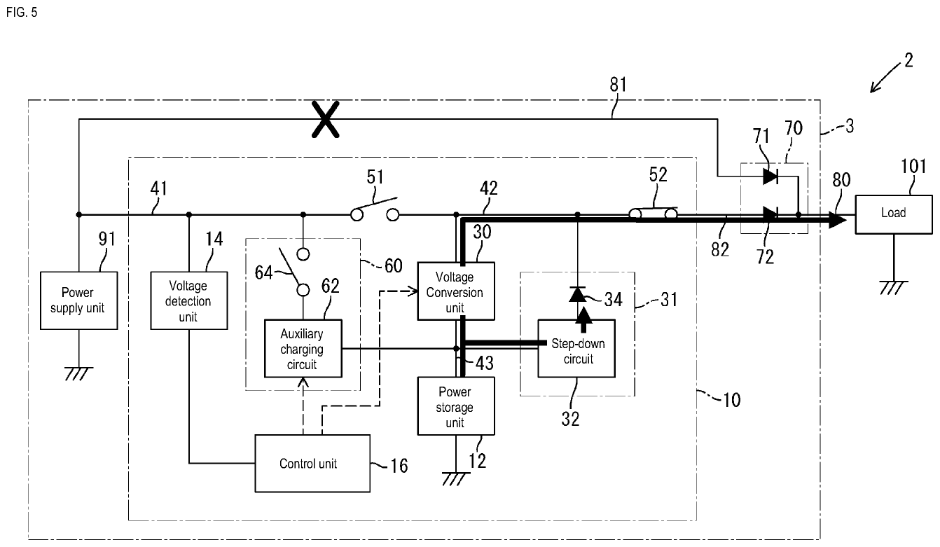

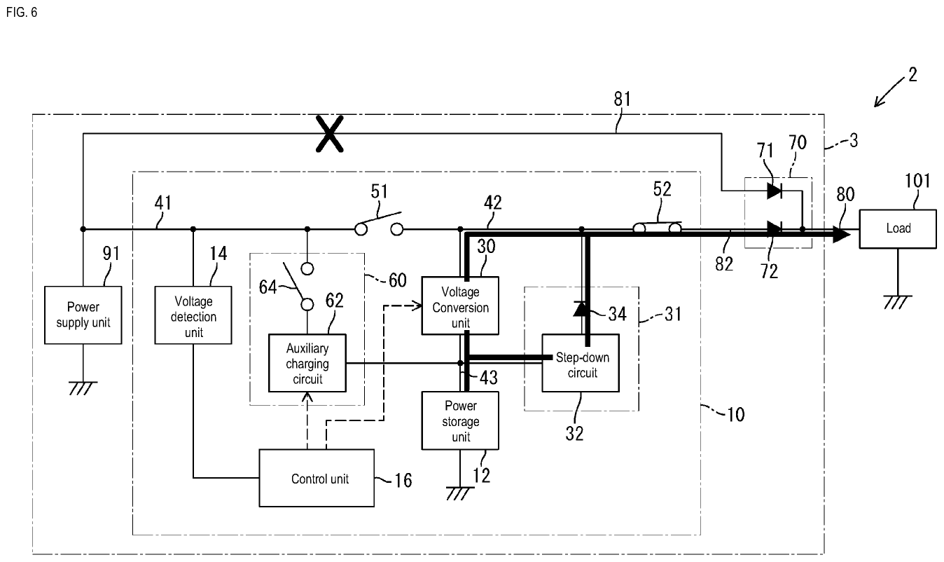

However, if for some reason the voltage applied to the first power path 81 falls below the voltage applied to the second power path 82 during the second control, a current immediately flows from the second power path 82 to the common power path 80, as shown in FIG. 5. Specifically, if the voltage applied to the end portion of the first power path 81 (the anode of the diode 71) is smaller than the voltage applied to the end portion of the second power path 82 (the anode of the diode 72), out of the first power path 81 and the second power path 82, only the current of the second power path 82 flows to the common power path 80, as shown in FIG. 5. Even if a current flows from the second power path 82 to the common power path 80 in this manner, when the voltage value V2 of the second conductive path 42 is greater than the aforementioned predetermined value (that is, V2>Vb−Vf), no current is output from the step-down unit 31 to the second conductive path 42, as shown in FIG. 5. However, if the voltage value V2 of the second conductive path 42 decreases due to an increase in the load current or the like, and the voltage value V2 falls below the aforementioned predetermined value (that is, if V2<Vb−Vf), a current flows from the step-down unit 31 to the second conductive path 42, as shown in FIG. 6. Thus, a decrease in the voltage value V2 caused by an increase in a load voltage or the like can be suppressed. Note that FIGS. 5 and 6 illustrate a case where a ground fault has occurred somewhere on the first power path 81.

### Third Control

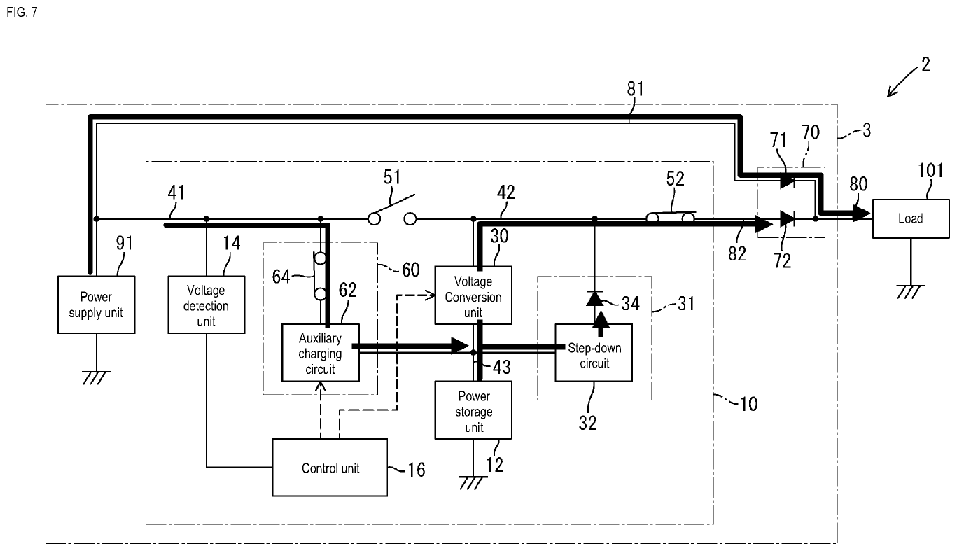

FIG. 7 is a diagram describing the third control. When the predetermined third condition is met, the control unit 16 initiates the third control. The above “third condition” may be, for example, “the output voltage applied by the power storage unit 12 to the third conductive path 43 reaching or falling below a threshold value while the second control is being executed”, or another condition. In the following representative example, the third condition is “the output voltage applied by the power storage unit 12 to the third conductive path 43 reaching or falling below a threshold value (first threshold value) while the second control is being executed”. The threshold value (first threshold value) is a value that is greater than 0 and is greater than the output voltage of the fully charged power storage unit 12. The threshold value (first threshold value) may be a predetermined fixed value, or a value that can be updated or changed.

The third control is control for turning off the first switch 51, turning on the second switch 52, bringing the auxiliary charging unit 60 into a supply state (a state where a charging current is supplied to the power storage unit 12), and causing the voltage conversion unit 30 to perform a conversion operation of stepping-down the voltage applied to the third conductive path 43 and applying the resulting voltage to the second conductive path 42. In the example shown in FIG. 7, the control unit 16 performs the third control in which the third switch 64 is turned on, and the auxiliary charging circuit 62 is caused to perform an operation of supplying a charging current to the power storage unit 12 based on power from the power supply unit 91 (power that is supplied via the first conductive path 41). When the third control is performed, a current that is based on power from the power supply unit 91 is supplied to the power storage unit 12 via the auxiliary charging unit 60 and not via the first switch 51, while a voltage that is based on power from the power storage unit 12 is applied to the second power path 82, as indicated by the thick arrows shown in FIG. 7. Note that, if the termination condition of the third control is met while the third control is being executed, the control unit 16 terminates the third control. The termination condition of the third control may be the start switch of the vehicle in which the in-vehicle system 2 is mounted being turned off, or the charging voltage of the power storage unit 12 reaching a second threshold value. The second threshold value in this case is a value greater than the above threshold (first threshold). The second threshold may be, for example, the charging voltage of the fully charged power storage unit 12. When the third control is terminated in response to the charging voltage of the power storage unit 12 reaching the second threshold while the third control is being executed, the control unit 16 may switch from the third control to the second control.

In the third control as well, the value (second target value) of the voltage applied by the voltage conversion unit 30 to the second conductive path 42 according to the third control is slightly smaller than the value of the voltage applied to the first power path 81 when the power supply unit 91 is fully charged. Thus, as long as the power supply unit 91 is fully charged and operating normally (not in a failure state, and can appropriately supply power that is based on the power supply unit 91 to the load 101), a current is allowed to flow from the first power path 81 to the common power path 80, and no current is allowed to flow from the second power path 82 to the common power path 80, as shown in FIG. 7. In this example as well, if the voltage applied to the end portion of the first power path 81 (the anode of the diode 71) is greater than the voltage applied to the end portion of the second power path 82 (the anode of the diode 72), out of the first power path 81 and the second power path 82, only the current from the first power path 81 flows to the common power path 80, as shown in FIG. 7.

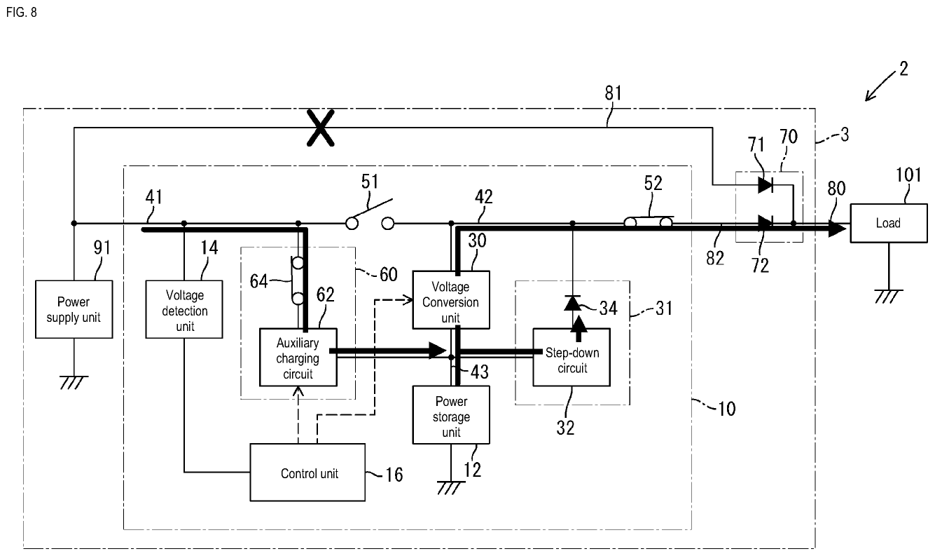

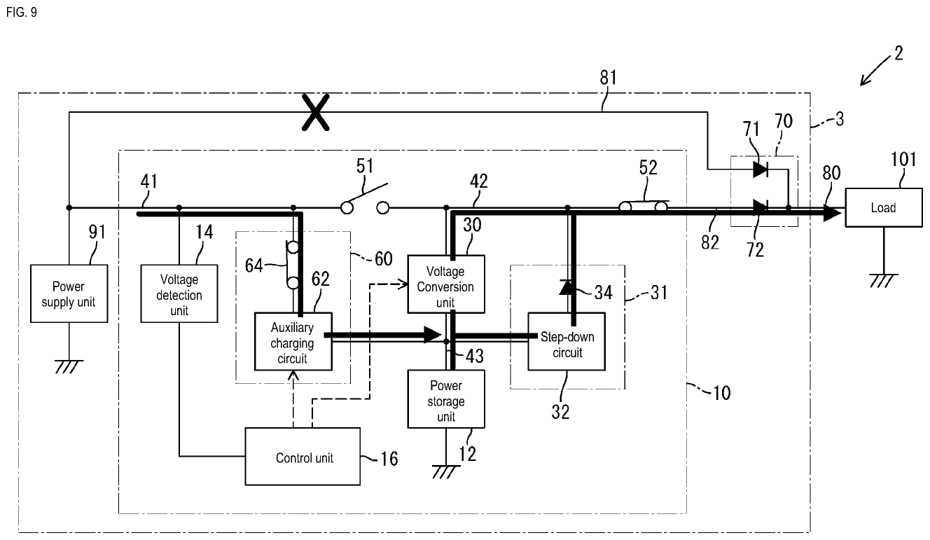

However, if for some reason the voltage applied to the first power path 81 falls below the voltage applied to the second power path 82 during the third control, a current immediately flows from the second power path 82 to the common power path 80, as shown in FIG. 8. Specifically, if the voltage applied to the end portion of the first power path 81 (the anode of the diode 71) is smaller than the voltage applied to the end portion of the second power path 82 (the anode of the diode 72), out of the first power path 81 and the second power path 82, only the current of the second power path 82 flows to the common power path 80, as shown in FIG. 8. Even if a current flows from the second power path 82 to the common power path 80 in this manner, when the voltage value V2 of the second conductive path 42 is greater than the aforementioned predetermined value (that is, V2>Vb−Vf), no current is output from the step-down unit 31 to the second conductive path 42, as shown in FIG. 8. However, if the voltage value V2 of the second conductive path 42 is reduced due to an increase in the load current or the like, and the voltage value V2 falls below the aforementioned predetermined value (that is, if V2<Vb−Vf), a current flows from the step-down unit 31 to the second conductive path 42, as shown in FIG. 9. Thus, a decrease in the voltage value V2 caused by an increase in the load voltage or the like can be suppressed. Note that FIGS. 8 and 9 illustrate a case where a ground fault has occurred somewhere on the first power path 81.

### Examples of Effects

If the voltage of the second conductive path 42 has not decreased to an extent where it reaches the predetermined value during a backup operation where the voltage conversion unit 30 applies an output voltage to the second conductive path 42, the power supply control device 10 can utilize the advantages of the voltage conversion unit 30 by causing the voltage conversion unit 30 to stop the passage of a current from the step-down unit 31 to the second conductive path 42. On the other hand, if a current flowing to the load 101 suddenly increases and the voltage of the second conductive path 42 decreases to an extent where it reaches the predetermined value during the backup operation, the power supply control device 10 can suppress a decrease in the voltage of the second conductive path 42 by causing a current to flow from the step-down unit 31 to the second conductive path 42.

A low dropout regulator is used as the step-down circuit 32, and thus it is possible to realize a smaller configuration where the power supply control device 10 can, when there is a sudden decrease in the voltage of the second conductive path 42, quickly cause a current to flow to the second conductive path 42 and suppress a decrease in the voltage thereof. Furthermore, even if there is a sudden increase in a current to the extent where the voltage conversion unit 30 cannot steadily maintain output, instantaneous output from the low dropout regulator makes it easier to stabilize the voltage of the second conductive path.

When the voltage of the second conductive path 42 has decreased to the extent that the potential difference between the anode and the cathode of the diode 34 exceeds the forward voltage of the diode 34, the power supply control device 10 can immediately supply a current that is based on output from the step-down circuit 32 to the second conductive path 42. On the other hand, if the potential difference between the anode and the cathode of the diode 34 is less than the forward voltage of the diode 34, or the potential of the cathode is greater than the potential of the anode, the power supply control device 10 can utilize the advantages of the voltage conversion unit 30 by causing the voltage conversion unit 30 to stop the passage of a current from the step-down unit 31 to the second conductive path 42. For example, if the voltage conversion unit 30 is more efficient than the step-down circuit 32, it is easier to increase efficiency by supplying power using the voltage conversion unit 30 than using the step-down circuit 32.

The power supply control device 10 can charge the power storage unit 12 by executing the first control to cause the voltage conversion unit 30 to perform the first conversion operation, and can discharge the power storage unit 12 by executing the second control to cause the voltage conversion unit 30 to perform the second conversion operation. The power supply control device 10 can easily keep the second conductive path 42 and the second power path 82 near the target value while executing the second control, and can go on stand-by or supply power to the load in a state where the voltage near the target value is output. On the other hand, if the current flowing through the second conductive path 42 and the second power path 82 suddenly increases while the second control is being executed, and the voltage of the second conductive path 42 rapidly decreases to an extent where it reaches the predetermined value, a current can be caused to quickly flow from the step-down unit 31 to the second conductive path 42, and thus a further decrease in the voltage can be suppressed.

### Other Embodiments

The present disclosure is not limited to the embodiments described using the above description and diagrams. For example, features of the aforementioned embodiments or the following embodiments can be combined, provided no contradiction arises. Also, any of the features of the above description or following embodiments can also be omitted if they are not clearly stated as being essential. Furthermore, the above embodiments may be modified as follows.

In the first embodiment, the power supply control device 10 includes the power storage unit 12, but the power storage unit 12 may be provided outside of the power supply control device 10. That is, the power storage unit 12 does not need to be included in the power supply control device 10.

In the first embodiment, the output voltage of the fully charged power supply unit 91 is smaller than the output voltage of the fully charged power storage unit 12, but the output voltage of the fully charged power supply unit 91 may be larger than the output voltage of the fully charged power storage unit 12. In this case, it is sufficient that the first control is control for turning on the first switch 51 and causing the voltage conversion unit 30 to perform an operation of stepping down the voltage applied to the second conductive path 42 and applying the resulting voltage to the third conductive path 43. Also, it is sufficient that the second control is control for turning off the first switch 51, turning on the second switch 52, bringing the auxiliary charging unit 60 into a stopped state (a state where no current is supplied to the power storage unit 12), and causing the voltage conversion unit 30 to perform an operation of stepping up the voltage applied to the third conductive path 43 and applying the resulting voltage to the second conductive path 42. It is sufficient that the third control is control for turning off the first switch 51, turning on the second switch 52, bringing the auxiliary charging unit 60 into a supply state (a state where a current is supplied to the power storage unit 12), and causing the voltage conversion unit 30 to perform a conversion operation of stepping up the voltage applied to the third conductive path 43 and applying the resulting voltage to the second conductive path 42.

In the power supply system 3, if the voltage of the first power path 81 enters a predetermined voltage reduction state where it decreases to a voltage smaller than the voltage of the second power path 82 while the second or third control is being performed, power is supplied to the load 101 via the second power path 82. Regarding this point, in the first embodiment, “a predetermined voltage reduction state” is a state where the voltage of the first power path 81 is lower than the voltage of the second power path 82, but the present disclosure is not limited to this example. The phrase “a predetermined voltage reduction state” may be a state where the voltage of the first power path 81 is smaller than the voltage of the second power path 82 by a fixed value. In either case, “in a normal state that is not the predetermined voltage reduction state”, the supply of power to the load 101 via the second power path 82 is blocked. Also, in either case, when performing the second control, the control unit 16 may cause the voltage conversion unit 30 to perform a conversion operation of applying the output voltage of the normal state (specifically, an output voltage where the voltage applied to the second power path 82 is slightly lower than the voltage applied to the first power path 81) to the second conductive path 42.

In the first embodiment, when the first control is performed in response to the aforementioned first condition being met, the control unit 16 can perform the first control until the termination condition of the first control is met, and switch from the first control to the second control in response to the termination condition of the first control being met, but the present disclosure is not limited to this example. For example, the first control may be performed until the termination condition of the first control is met, and then the first control may be switched to the third control. For example, the first control may be switched to the third control before the charging voltage of the power storage unit 12 reaches the second threshold value (for example, the threshold value indicating full charge), and after the charging voltage of the power storage unit 12 has reached the second threshold value due to the third control, the third control may be switched to the second control.

In the first embodiment, one example of the selection unit was given, but the selection unit 70 is not limited to a configuration such as that shown in FIG. 1 (a configuration including the diodes 71 and 72), and it is sufficient to employ a configuration where reverse current prevention control can be performed similarly to the selection unit 70 in FIG. 1. For example, a first relay comprised of a mechanical or semi-conductor relay may be provided in place of the diode 71, and a second relay comprised of a mechanical or semi-conductor relay may be provided in place of the diode 72. It is sufficient that the first and second relays are configured to allow passage of a current therethrough in two directions when on, and block passage of a current therethrough in two directions when off, for example. If such a configuration is employed, the power supply control device 10, the load 101, or another electronic control device may monitor the voltage of the power supply unit 91 (for example, the voltage of the power path 81), and turn on the first relay and turn off the second relay when the voltage of the power supply unit 91 is greater than or equal to a predetermined threshold, and turn off the first relay and turn on the second relay when the voltage of the power supply unit 91 is less than the predetermined threshold. Alternatively, an un-shown switching device may turn on the first relay and turn off the second relay when the voltage of the first power path 81 is greater than or equal to the voltage of the second power path 82, and turn off the first relay and turn on the second relay when the voltage of the first power path 81 is smaller than the voltage of the second power path 82.

In the first embodiment, the selection unit 70 is constituted by a component different from the power supply control device 10, but the selection unit 70 may be integrated as a portion of the power supply control device 10. Alternatively, the selection unit 70 may be integrated into the load 101 as a portion of the load 101.

The disclosed embodiments are illustrative in all regards and not to be construed as limiting. The scope of the present disclosure is defined by the claims and not by the above disclosed description, and all changes that come within the meaning and range of equivalency of the claims are intended to be embraced therein.

1. A power supply control device to be used in a power supply system including a power supply unit, a power storage unit, a first power path along which power that is based on the power supply unit is supplied to a load, and a second power path along which power that is based on the power storage unit is supplied to the load, the power supply control device comprising:
a first conductive path that is a path along which power that is based on the power supply unit is transmitted;
a second conductive path that is a path along which power is transmitted to the second power path, and is configured to be interposed between the second power path and the first conductive path;
a third conductive path that is configured to be electrically connected to the power storage unit;
a voltage conversion unit configured to perform voltage conversion between the second conductive path and the third conductive path;
a switch that is provided between the first conductive path and the second conductive path, and is configured to switch between an on state where a current is allowed to flow from the first conductive path to the second conductive path and an off state where a current is blocked from flowing between the first conductive path and the second conductive path;
a step-down unit that includes a step-down circuit configured to step-down a voltage applied to the third conductive path and output the resulting voltage, and that is configured to, when a voltage applied to the second conductive path decreases to an extent where the voltage reaches a predetermined value that is less than or equal to an output voltage of the step-down circuit, cause a current that is based on the output voltage of the step-down circuit to flow to the second conductive path; and
a control unit configured to control the voltage conversion unit,
wherein the step-down unit has a diode,
the voltage output by the step-down circuit is applied to an anode of the diode, and a cathode of the diode is electrically connected to the second conductive path,
the control unit performs control for causing the voltage conversion unit to apply an output voltage of a target value to the second conductive path, and
the target value is larger than a value obtained by subtracting a value of a forward voltage of the diode from a value of the output voltage of the step-down circuit.

2. The power supply control device according to claim 1,
wherein the step-down circuit is a low dropout regulator.

3. (canceled)

4. The power supply control device according to claim 1, further comprising:
a control unit configured to control the switch and the voltage conversion unit,
wherein the control unit performs first control and second control,
the first control is control for turning on the switch and causing the voltage conversion unit to perform a first conversion operation of stepping down or stepping up a voltage applied to the second conductive path and applying the resulting voltage as an output voltage to the third conductive path,
the second control is control for turning off the switch and causing the voltage conversion unit to perform a second conversion operation of stepping down or stepping up a voltage applied to the third conductive path and applying the resulting voltage as an output voltage of a target value to the second conductive path,
the target value is a value that is higher than the predetermined value, and
the step-down circuit outputs a voltage that is lower than the target value.
